(19) United States
(12) Patent Application Publication
(10) Pub. No.: US 2026/0112677 A1
(43) Pub. Date: Apr. 23, 2026

(54) NOTCHING DEVICE FOR ELECTRODE SUBSTRATE FOR A SECONDARY BATTERY

(71) Applicant: SAMSUNG SDI CO., LTD., Yongin-si (KR)

(72) Inventor: HOYOUNG JUNG, Yongin-si (KR)

(21) Appl. No.: 19/204,985

(22) Filed: May 12, 2025

(30) Foreign Application Priority Data
Oct. 21, 2024 (KR) 10-2024-0143956

(51) Int. Cl. H01M 10/04; B26F 1/14

(52) U.S. Cl. CPC H01M 10/0404; B26F 1/14

(57) ABSTRACT

A notching device for an electrode substrate for a secondary battery. The notching device may include a die that may be configured to receive an electrode substrate thereon, a stripper that may be configured to press and fix the electrode substrate disposed on the die, and a punch, which may move in a vertical direction that is perpendicular to a first direction, the punch moving next to the die and being configured to cut the electrode substrate disposed on the die. The punch may have an accommodation groove in a side surface facing the die, the punch may divide the side surface into a first side portion and a second side portion, and the punch may extend in a first direction. A first cutting portion and a second cutting portion may be respectively formed at an end portion of the first side portion and an end portion of the second side portion and may be configured to continuously cut a to-be-cut portion of the electrode substrate.

### CROSS-REFERENCE TO RELATED APPLICATION

This application is based on and claims priority under 35 U.S.C. § 119 to Korean Patent Application No. 10-2024-0143956, filed on Oct. 21, 2024, in the Korean Intellectual Property Office, the disclosure of which is incorporated by reference herein in its entirety.

### BACKGROUND

### 1. Field

Embodiments of the disclosure relate to a notching device for an electrode substrate for a secondary battery, and more specifically, to a notching device for an electrode substrate for a secondary battery, of which the notching device is capable of improving the quality of a cut surface of an electrode for the secondary battery.

### 2. Description of the Related Art

Unlike primary batteries, secondary batteries are batteries that are repeatedly charged and discharged. These secondary batteries are widely used in portable devices such as mobile phones, laptop computers, and camcorders as well as transportation means such as hybrid vehicles and electric vehicles, and the scope of application thereof is gradually expanding.

A process of manufacturing a secondary battery may be divided into an electrode manufacturing process and an assembly process. The electrode manufacturing process may include stirring, coating, drying, cutting, and the like, and the assembly process may include winding, jelly roll insertion and electrolyte injection, and sealing processes, and the like.

A secondary battery includes an electrode assembly for charging and discharging current, a case or pouch for accommodating the electrode assembly and an electrolyte, and an electrode terminal connected to the electrode assembly and extending out of the case or pouch. An electrode assembly may be formed as a jelly roll type formed by winding an electrode and a separator or as a stack type formed by stacking an electrode and a separator.

An electrode used in a stack-type electrode assembly is manufactured by notching an electrode substrate including a coated portion and a non-coated portion. A notching device used in a notching process of an electrode substrate includes a lower plate die assembly including a die and an upper plate die assembly including a punch. In a notching device, an electrode is manufactured by notching an electrode substrate, which is introduced between a lower plate die assembly and an upper plate die assembly, into a desired shape through a relative elevation operation of a die and a punch.

However, since a non-coated portion of the electrode substrate is very thin, the electrode substrate may be accurately cut only when the punch and the die should be maintained to have almost no gap. In prior tests, when an electrode substrate was notched in a state in which there was a large gap between a punch and a die, burrs were generated on a cut surface of an electrode, which lowered cutting quality.

In some embodiments, when a gap between a die and a punch is made smaller to prevent the generation of such burrs, a more precise assembly is required, which increases the number of processes and increases costs. Further, a die and a punch could be damaged if the die and punch are improperly assembled.

### SUMMARY

Embodiments of the disclosure are directed to solve the above problems and/or limitations, and a first object thereof is to provide a notching device for an electrode substrate for a secondary battery, which improves the cutting quality of an electrode and reduces the occurrence of defects.

The objects to be solved by the disclosure are not limited to the above-described objects, and other objects and advantages of the disclosure, which are not described above, may be understood by the following description. It is appreciated that the problems and advantages to be solved by the disclosure may be realized by combinations of aspects and/or embodiments thereof.

Some embodiments of the disclosure provide a notching device for an electrode substrate for a secondary battery. The notching device may include a die configured to receive an electrode substrate thereon, a stripper configured to press and fix the electrode substrate disposed on the die, and a punch, which may move in a vertical direction that is perpendicular to a first direction, the punch moving next to the die and being configured to cut the electrode substrate disposed on the die. The punch may have an accommodation groove in a side surface facing the die, the punch divides the side surface into a first side portion and a second side portion, and the punch extends in the first direction. A first cutting portion and a second cutting portion may be respectively formed at an end portion of the first side portion and an end portion of the second side portion and continuously cut a to-be-cut portion of the electrode substrate.

In some embodiments, the first cutting portion may be connected to a lower surface of the punch, and the lower surface of the punch may have an inclination forming an acute angle with the first side portion.

In some embodiments, the accommodation groove may include a first inner surface connected to the first side portion and a second inner surface connected to the second side portion. The first inner surface and the second inner surface may be disposed parallel to each other.

In some embodiments, the first inner surface and the second inner surface each may have a same inclination as a lower surface of the punch connected to the first side portion of the punch.

In some embodiments, the accommodation groove may include a first inner surface connected to the first side portion and a second inner surface connected to the second side portion, the first inner surface and the second inner surface having inclinations of different angles with respect to a line perpendicular to the first side portion.

In some embodiments, a cross-sectional shape of the accommodation groove shows a curve such that the accommodation groove may have a curved surface.

In some embodiments, a separation distance between the first side portion and the second side portion may be equal to a depth of the accommodation groove.

In some embodiments, the first side portion may be spaced apart from the die by a first gap in a second direction, and the second side portion may be spaced apart in the second direction from the die by a second gap different from the first gap.

In some embodiments, the second gap may have a width less than the first gap, and the second gap may be positioned higher than the first gap in the vertical direction.

In some embodiments, the punch may have a plurality of accommodation grooves, which may be formed in the side surface, the plurality of accommodation grooves each extending in the first direction and being configured to divide the side surface into a plurality of side portions. Cutting portions may be respectively formed at end portions of the plurality of side portions, the cutting portions being configured to continuously cut the to-be-cut portion of the electrode substrate.

Other embodiments of the disclosure provide a notching device for an electrode substrate for a secondary battery. The notching device may include a die configured to receive an electrode substrate thereon, a stripper configured to press and fix the electrode substrate disposed on the die, and a punch, which may move in a vertical direction that is perpendicular to a first direction, the punch moving next to the die and being configured to cut the electrode substrate disposed on the die. The punch may include a first cutting portion and a second cutting portion, which may be spaced apart from each other in the vertical direction of the punch and may be configured to continuously cut a to-be-cut portion of the electrode substrate. An accommodation groove may be formed between the first cutting portion and the second cutting portion and may be recessed from a side surface of the punch by a depth.

In some embodiments, the first cutting portion may be connected to a lower surface of the punch, and the lower surface of the punch may be inclined in the vertical direction.

In some embodiments, the accommodation groove may include a first inner surface and a second inner surface facing the first inner surface, and the first inner surface and the second inner surface may be parallel to each other.

In some embodiments, the first inner surface and the second inner surface may have a same inclination as a lower surface of the punch.

In some embodiments, the accommodation groove may include a first inner surface and a second inner surface facing the first inner surface, the first inner surface and the second inner surface having inclinations of different angles with respect to a line perpendicular to the side surface.

In some embodiments, a cross-sectional shape of the accommodation groove shows a curve such that the accommodation groove may have a curved surface.

In some embodiments, a length of the accommodation groove in the vertical direction may be equal to a depth of the accommodation groove.

In some embodiments, the first cutting portion and the second cutting portion may be respectively connected to a first side portion and a second side portion, the first side portion may be spaced apart from the die by a first gap in a second direction, and the second side portion may be spaced apart from the die by a second gap different from the first gap in the second direction.

In some embodiments, the second gap may have a width less than the first gap and the second gap may be positioned higher than the first gap in the vertical direction.

In some embodiments, the punch may have a plurality of accommodation grooves, which may be formed in the side surface, may extend in the first direction, and may divide the side surface into a plurality of side portions. The cutting portions may be formed at respective end portions of the plurality of side portions and may be configured to continuously cut the to-be-cut portion of the electrode substrate.

Other aspects, features, and advantages other than those described above will become apparent from the following drawings, claims, and detailed description of the disclosure.

### BRIEF DESCRIPTION OF THE DRAWINGS

The above and other aspects, features, and advantages of embodiments of the disclosure will be more apparent from the following description taken in conjunction with the accompanying drawings in which:

FIG. 1 is a schematic front view illustrating a notching device for an electrode substrate for a secondary battery according to embodiments of the present disclosure;

FIG. 2 is a side view of the notching device of FIG. 1 according to embodiments of the present disclosure;

FIG. 3 is a perspective view illustrating a punch applied to the notching device of FIG. 1 according to embodiments of the present disclosure;

FIG. 4 is a side view of the punch of FIG. 3 according to embodiments of the present disclosure;

FIGS. 5A to 5D are cross-sectional views illustrating a cutting process performed by a notching device for an electrode substrate for a secondary battery according to embodiments of the present disclosure;

FIG. 6 is a view illustrating a punch according to embodiments of the present disclosure;

FIG. 7 is a view illustrating a punch according to embodiments of the present disclosure;

FIG. 8 is a view illustrating a punch according to embodiments of the present disclosure;

FIG. 9 is a schematic view of a notching device for an electrode substrate for a secondary battery according to embodiments of the present disclosure; and

FIG. 10 is an enlarged view of area A of FIG. 9 according to embodiments of the present disclosure.

### DETAILED DESCRIPTION

Since the disclosure can apply various transformations and have various embodiments, specific embodiments will be illustrated in the drawings and described in detail in the detailed description. However, it should be understood that examples of the present disclosure are not intended to limit the disclosure to specific embodiments, as the disclosure includes all transformations, equivalents, and substitutes of embodiments discussed below. In describing the disclosure, when it is determined that the specific description of the known related art unnecessarily obscures the gist of the disclosure, the detailed description thereof will be omitted.

The terms, “first,” “second,” and the like may be simply used for description of various components, but those meanings may not be limited to the restricted meanings. The terms are used only to distinguish one component from another component.

The terms used herein are merely used to describe specific embodiments and are not intended to limit the disclosure. An expression used in the singular encompasses the expression of the plural, unless it has a clearly different meaning in context. Moreover, components in each drawing may be exaggerated, omitted, or schematically illustrated for convenience and/or for clearly showing features of embodiments of the present disclosure, and sizes of components in the drawings do not necessarily reflect actual sizes of the components.

In the description of each component, when a component is referred to as being formed “on” or “under” another component, it may be directly “on” or “under” the other component or be indirectly formed with intervening components therebetween. It will also be understood that “on” or “under” the component is described relative to an orientation of a respective figure of the drawings.

Hereinafter, embodiments of the disclosure will be described in detail with reference to the accompanying drawings, wherein like reference numerals denote the same or corresponding components throughout the drawings, and a redundant description thereof will be omitted.

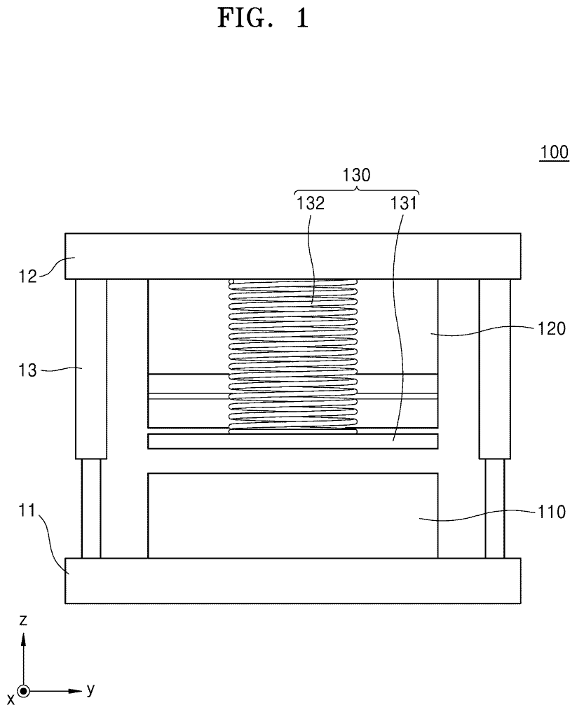

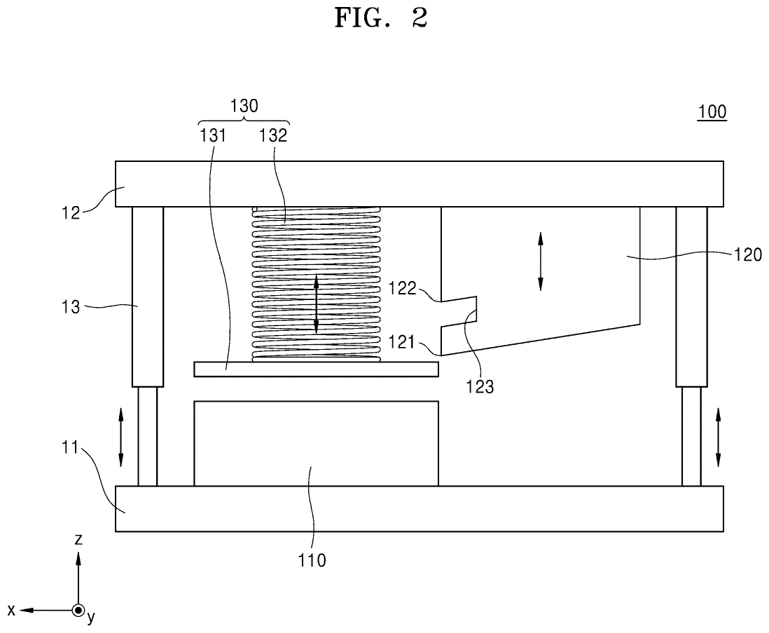

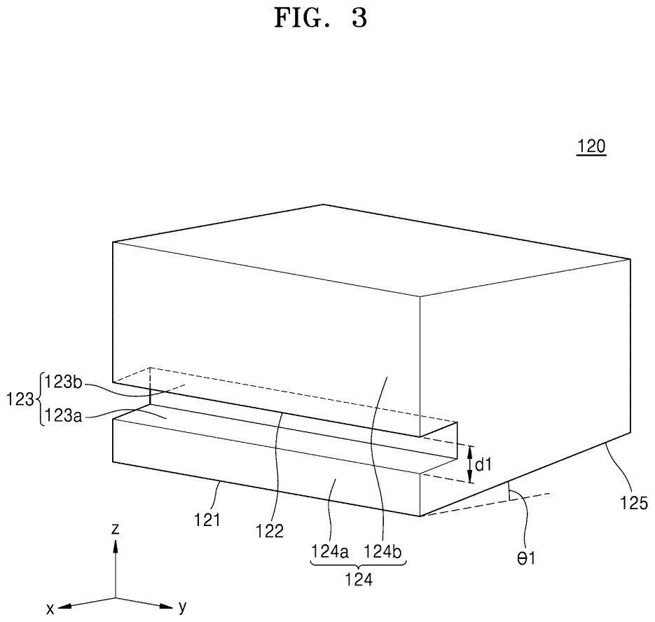

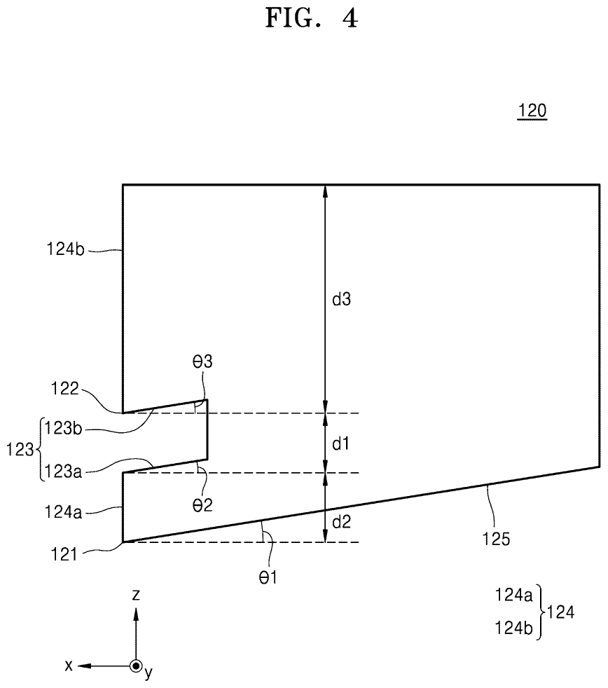

FIG. 1 is a schematic front view illustrating a notching device 100 for an electrode substrate for a secondary battery according to embodiments of the present disclosure. FIG. 2 is a side view of the notching device 100 of FIG. 1 according to embodiments of the present disclosure. FIG. 3 is a perspective view illustrating a punch 120 applied to the notching device 100 of FIG. 1 according to embodiments of the present disclosure. FIG. 4 is a side view of the punch 120 of FIG. 3 according to embodiments of the present disclosure.

Referring to FIGS. 1 to 4, a notching device 100 for an electrode substrate for a secondary battery may include a die 110, a punch 120, and a stripper 130. In an embodiment, the notching device 100 may further include a lower assembly 11, an upper assembly 12, and an elevation member 13.

The lower assembly 11 and the upper assembly 12 may be disposed parallel to each other. The die 110 may be installed on one surface (i.e., an upper surface in FIGS. 1 and 2) of the lower assembly 11. The lower assembly 11 may fix and support the die 110.

The punch 120 and/or the stripper 130 may be installed on one surface (i.e., a lower surface in FIGS. 1 and 2) of the upper assembly 12. Although the drawing illustrates an example in which the stripper 130 is installed on one upper assembly 12 together with the punch 120, but the disclosure is not limited thereto, and the punch 120 and the stripper 130 may be respectively installed on different upper assemblies and may be each independently movable.

The lower assembly 11 and the upper assembly 12 may be connected by the elevation member 13. A plurality of elevation members 13 may be provided. The elevation member 13 may guide the movement of the lower assembly 11 or the upper assembly 12.

A length of the elevation member 13 may be adjusted, and as the length of the elevation member 13 is adjusted, the upper assembly 12 or the lower assembly 11 may move in a vertical direction (i.e., a z direction in FIGS. 1 and 2) to move toward or away from the lower assembly 11 or the upper assembly 12.

The elevation member 13 may have a cylindrical structure, but one or more embodiments are not limited thereto. The elevation member 13 may have any structure as long as the structure may guide the movement of the lower assembly 11 or the upper assembly 12 and may adjust a distance between the lower assembly 11 and the upper assembly 12.

FIGS. 1 and 2 illustrate an embodiment in which the die 110, the punch 120, and the stripper 130 are installed on the lower assembly 11 and the upper assembly 12, and the elevation member 13 moves the die 110 and the punch 120 such that the die 110 and punch 120 move with the elevation member 13, but the disclosure is not limited thereto. The configurations of the lower assembly 11, the upper assembly 12, and the elevation 13 may be modified in various ways.

The die 110 may be installed on one surface of the lower assembly 11. The die 110 may have a quadrangular block shape to correspond to a shape of an electrode substrate. The electrode substrate may be disposed on an upper surface of the die 110.

The punch 120 may be disposed above the die 110 and may be disposed to face the die 110. The punch 120 may be positioned not to overlap the die 110 on an xy plane perpendicular to the height direction (i.e., the z direction). The punch 120 and the die 110 may form a gap in a second direction (i.e., an x direction) and may be vertically misaligned with each other.

The punch 120 may be movable in the height direction (i.e., the z direction). The punch 120 may be installed on one surface of the upper assembly 12 and may be moved in a height direction z in conjunction with the movement of the upper assembly 12 in the height direction z.

The punch 120 may have a block shape corresponding to a shape of the die 110. The punch 120 may be such that a width thereof in a y direction corresponds to a width of the die 110 in the y direction.

An accommodation groove 123 extending in a first direction (i.e., a y direction in FIGS. 3 and 4) may be formed in a side surface 124 of the punch 120. The side surface 124 of the punch 120, in which the accommodation groove 123 is formed, may be a side surface facing the die 110 in the y direction. The first direction in which the accommodation groove 123 extends may be a direction that is parallel to the upper surface of the die 110.

The accommodation groove 123 may be recessed from the side surface 124 by a depth. A depth (i.e., an x-direction length) of the accommodation groove 123 may correspond to a first length d1 which is a length of the accommodation groove 123 of the side surface 124 in the height direction (i.e., the z direction). Further, the accommodation groove 123 may be formed in a shape of a block having a quadrangular cross section, and a height and a width of the block may be equal to each other.

The first length d1 corresponding to a height of the accommodation groove 123 may have a value corresponding to a thickness of an electrode substrate to be cut. The first length d1 may be equal to a thickness of the electrode substrate. However, the disclosure is not limited thereto, and the first length d1 may have a value that is greater or less than the thickness of the electrode substrate.

The side surface 124 of the punch 120 may be divided into two areas by the accommodation groove 123. That is, the punch 120 may include a first side portion 124a and a second side portion 124b, which are respectively positioned at a lower side and an upper side with respect to the accommodation groove 123.

The accommodation groove 123 may include a first inner surface 123a connected to the first side portion 124a and a second inner surface 123b connected to the second side portion 124b. The first inner surface 123a and the second inner surface 123b may face each other. The first inner surface 123a and the second inner surface 123b may be parallel to each other.

An upper end portion of the first side portion 124a may be connected to the accommodation groove 123, and a lower end portion thereof may be connected to a lower surface 125 of the punch 120. In some embodiments, first cutting portion 121 may be formed at the lower end portion of the first side portion 124a. In some embodiments, the first cutting portion 121 may be formed at a position at which the first side portion 124a intersects the lower surface 125.

The first cutting portion 121 may intersect the die 110 and may cut an electrode substrate positioned between the first cutting portion 121 and the die 110. The first cutting portion 121 may have a length extending in the y direction.

A second cutting portion 122 may be formed at a lower end portion of the second side portion 124b. The lower end portion of the second side portion 124b may be connected to the accommodation groove 123, and the second cutting portion 122 may be formed at a position at which the second side portion 124b intersects the second inner surface 123b of the accommodation groove 123.

The second cutting portion 122 may be positioned a distance apart from the first cutting portion 121 in the height direction and may have a length extending in the y direction. The second cutting portion 122 may be disposed parallel to the first cutting portion 121. Further, a gap between the second cutting portion 122 and the die 110 may be equal to a gap between the first cutting portion 121 and the die 110.

The second cutting portion 122 may intersect the die 110 and may cut an electrode substrate positioned between the second cutting portion 122 and the die 110. The second cutting portion 122 may pass over a to-be-cut portion of the electrode substrate cut by the first cutting portion 121, thereby removing burrs remaining on a cut surface of the electrode substrate.

The second cutting portion 122 may cut the to-be-cut portion of the electrode substrate cut by the first cutting portion 121. Further, a process in which the second cutting portion 122 cuts the electrode substrate may be performed continuously after a process in which the first cutting portion 121 cuts the electrode substrate.

As the punch 120 is lowered while next to the die 110, the first cutting portion 121 may first cut the electrode substrate, and then the second cutting portion 122 may cut the electrode substrate. The electrode substrate may be cut twice by the first cutting portion 121 and the second cutting portion 122.

The lower surface 125 of the punch 120 may have an inclination. In some embodiments, the lower surface 125 be inclined upward in a direction away from the first cutting portion 121. For example, an inclination angle θ1 of the lower surface 125, which is an angle formed between the lower surface 125 and a reference line perpendicular to the first side portion 124a, may have a value selected from a range of about 0.1 degree to 2 degrees.

The lower surface 125 of the punch 120 may be inclined upward from the first cutting portion 121 so that an angle between the lower surface 125 and the first side portion 124a may be an acute angle of less than 90 degrees, and a sharpness of the first cutting portion 121 may be improved.

The first inner surface 123a and the second inner surface 123b of the accommodation groove 123 may have an inclination. In some embodiments, the first inner surface 123a may be inclined upward in a direction away from the first side portion 124a, and the second inner surface 123b may be inclined upward in a direction away from the second side portion 124b. That is, the first inner surface 123a and the second inner surface 123b may have inclinations in a same direction.

For example, an inclination angle θ2 of the first inner surface 123a may be equal to an inclination angle θ3 of the second inner surface 123b. A reference line of the second angle θ2 may be a line extending from a point, at which the first inner surface 123a intersects the first side portion 124a, to be perpendicular to the first side portion 124a, and a reference line of the third angle θ3 may be a line extending from a point, at which the second inner surface 123b intersects the second side portion 124b, to be perpendicular to the second side portion 124b.

In an embodiment, an inclination angle θ2 of the first inner surface 123a, an inclination angle θ3 of the second inner surface 123b, and an inclination angle θ1 of the lower surface 125 may all be equal to each other.

The second inner surface 123b may be inclined upward from the second cutting portion 122 so that an angle between the second inner surface 123b and the second side portion 124b may be an acute angle of less than 90 degrees, and the sharpness of the second cutting portion 122 may be improved.

A second length d2, which is a length of the first side portion 124a in the height direction (i.e., the z direction), may be equal to the first length d1 of the accommodation groove 123. Further, a third length d3, which is a length of the second side portion 124b in the height direction (i.e., the z direction), may be greater than the first length d1 of the accommodation groove 123.

In some embodiments, the stripper 130 may be disposed above the die 110. In some embodiments, the stripper 130 may be positioned to overlap the die 110 on the xy plane perpendicular to the height direction (i.e., the z direction). The stripper 130 may be installed on the upper assembly 12. The stripper 130 may fix an electrode substrate by pressing the electrode substrate toward the die 110 when the electrode substrate is cut.

The stripper 130 may include a plate 131 and a length adjustment portion 132 connected to the plate 131. The plate 131 may have one surface that is parallel to one surface of the die 110.

The length adjustment portion 132 may adjust an arrangement height of the plate 131. The length adjustment portion 132 may cause the plate 131 to move in a direction toward or away from the die 110. A length of the length adjustment portion 132 may be changed to cause the plate 131 to press an electrode substrate disposed on the die 110.

When the stripper 130 and the punch 120 are installed on one upper assembly 12, an electrode substrate that is primarily pressed by the stripper 130 may be additionally pressed and fixed as the upper assembly 12 is lowered together with the punch 120.

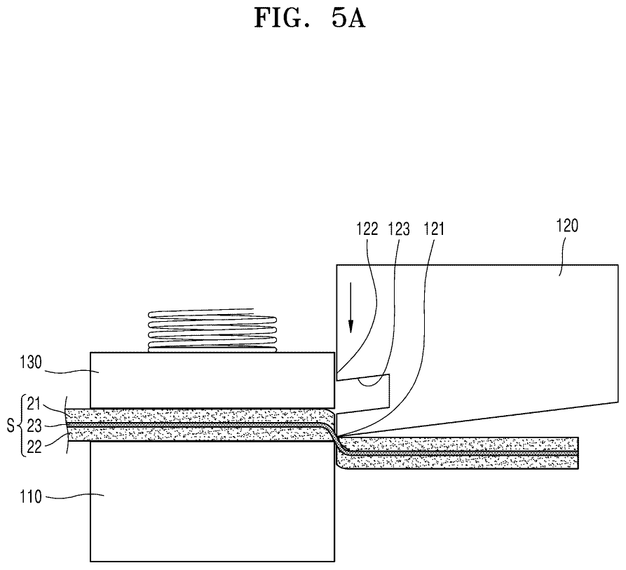

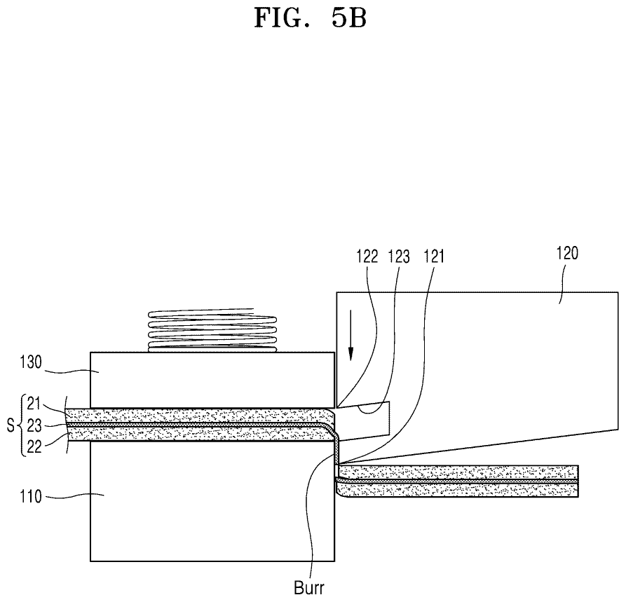

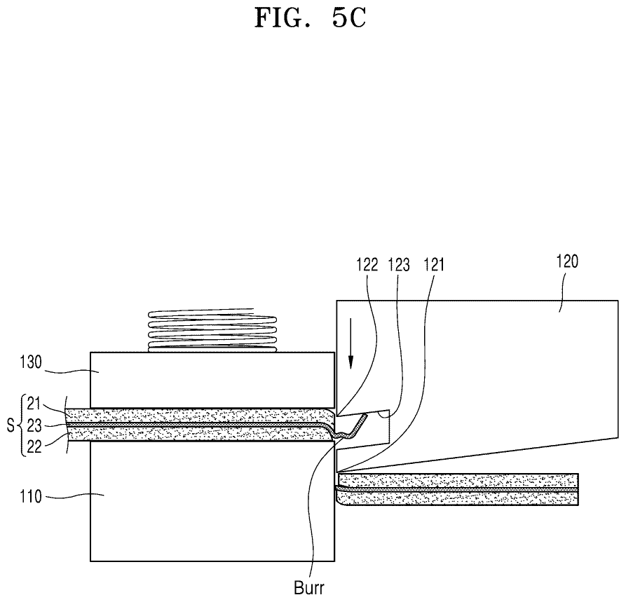

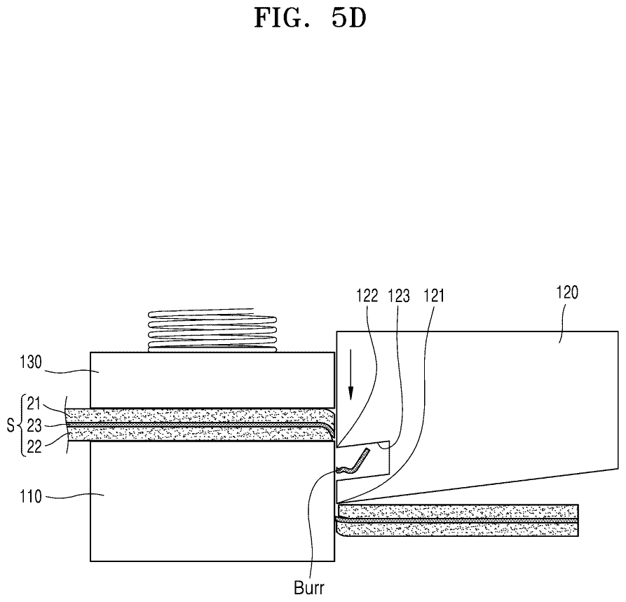

FIGS. 5A to 5D are cross-sectional views illustrating a process in which a notching device 100 for an electrode substrate for a secondary battery cuts an electrode substrate S according to embodiments of the present disclosure. For convenience of description, only cross sections of the electrode substrate S, and the die 110, punch 120, and stripper 130 of the notching device 100 are shown in FIGS. 5A to 5D.

As shown in FIG. 5A, the electrode substrate S may be disposed on the die 110, and the electrode substrate S may be fixed by pressing the electrode substrate S toward the die 110 through the stripper 130. The electrode substrate S may include a central portion 23, which is a metal film, and a first coating portion 21 and a second coating portion 22, which surround the central portion 23.

In a state in which the electrode substrate S is fixed, the punch 120 may be lowered toward the die 110 to start to cut the electrode substrate S. The first cutting portion 121 of the punch 120 may come into contact with the electrode substrate S first to start a first cutting process. The first cutting portion 121 may move to a height of a lower surface of the electrode substrate S to cut the electrode substrate S in a thickness direction.

The first coating portion 21 and the second coating portion 22 of the electrode substrate S may be mostly cut, but the central portion 23 may remain uncut because the central portion 23 has stronger tension than the first coating portion 21 and the second coating portion 22.

As shown in FIG. 5B, the punch 120 may be further lowered (i.e., slightly lowered than as shown in FIG. 5A) to cut the central portion 23 of the electrode substrate S. The central portion 23 of the electrode substrate S may be eventually cut by a pressing force of the punch 120, and the first cutting of the electrode substrate S is completed.

During such a first cutting process, the central portion 23 of the electrode substrate S may be deformed such that the central portion 23 protrudes further than a cut surface of the electrode substrate S, and burrs may be formed.

In some embodiments, when the first cutting is completed, the second cutting portion 122 of the punch 120 may start to pass over the cut surface of the electrode substrate S.

As shown in FIG. 5C, when the punch 120 is even further lowered (i.e., lowered slightly more than in FIG. 5B), burrs formed on the cut surface of the electrode substrate S may be accommodated in the accommodation groove 123. Further, the burr may have elasticity, may bounce upward to spread in a direction in which the electrode substrate S extends, and may be accommodated in the accommodation groove 123.

As shown in FIG. 5D, the punch 120 may be further lowered to perform second cutting through the second cutting portion 122. The second cutting portion 122 may be lowered in the height direction to intersect an upper edge of the die 110, and the burr may be cut on the cutting surface of the electrode substrate S through an interaction between the second cutting portion 122 and the die 110.

In some embodiments, a burr, which is removed through the second cutting, may be moved into the accommodation groove 123 and may be collected in a separate collection place.

In this way, the second cutting portion 122 may pass over the cut surface of the electrode substrate S to remove some defects (or, to completely remove defects) such as burrs that are not completely cut by the first cutting portion 121.

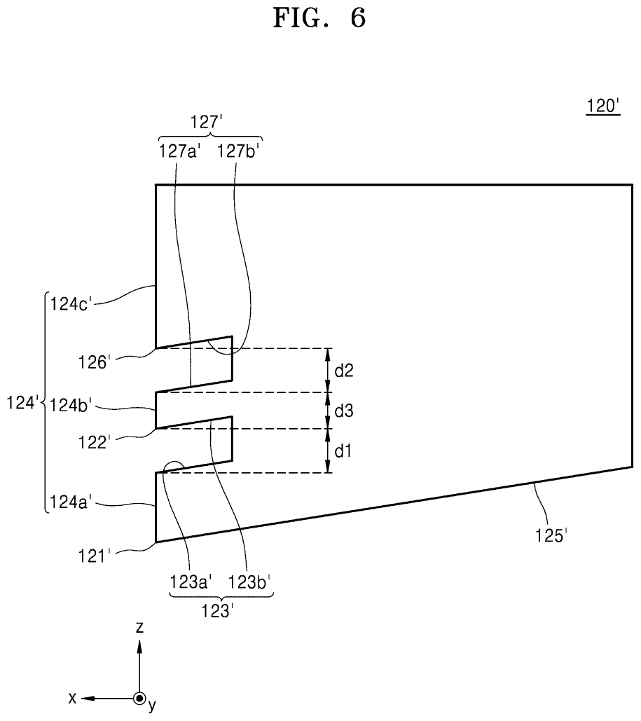

FIGS. 6 to 8 are views illustrating modified examples of the punch 120 shown in FIGS. 1 to 5D according to embodiments of the present disclosure. The modified examples of the punch 120 may have a distinguishing difference in structures of the accommodation groove 123, the first cutting portion 121, and the second cutting portion 122, and thus the accommodation groove 123, the first cutting portion 121, and the second cutting portion 122 will be mainly described.

Referring to FIG. 6, a plurality of accommodation grooves 123′ and 127′ may be formed in a side surface 124′ of a punch 120′. FIG. 6 illustrates an embodiment in which two accommodation grooves 123′ and 127′ are formed in the side surface 124′ of the punch 120′, but the number of accommodation grooves is not limited thereto.

In some embodiments, first accommodation groove 123′ and a second accommodation groove 127′ may have a same shape, but embodiments are not limited thereto. In some embodiments, the first accommodation groove 123′ and the second accommodation groove 127′ may be spaced a distance apart from each other in a height direction (i.e., the z direction). For example, a distance d3 between the first accommodation groove 123′ and the second accommodation groove 127′ may be equal to each of a height d1 of the first accommodation groove 123′ and a height of the second accommodation groove 127′, but, in other embodiments, the distance d3 is not limited thereto.

The side surface 124′ of the punch 120′ may include a plurality of side portions that are divided by forming the first accommodation groove 123′, having a first inner surface 123a′ of the first accommodation groove and a second inner surface 123b′ of the first accommodation groove, and the second accommodation groove 127′, having a first inner surface 127a′ of the second accommodation groove and a second inner surface 127b′ of the second accommodation groove. The side surface 124′ may include a first side portion 124a′ connected to a lower side of the first accommodation groove 123′, a second side portion 124b′ connected between the first accommodation groove 123′ and the second accommodation groove 127′, and a third side portion 124c′ connected to an upper side of the second accommodation groove 127′.

A cutting portion may be formed at a lower end portion of each side portion. In some embodiments, a first cutting portion 121′ may be formed at a lower end portion of the first side portion 124a′, a second cutting portion 122′ may be formed at a lower end portion of the second side portion 124b′, and a third cutting portion 126′ may be formed at a lower end portion of the third side portion 124c′. When n accommodation grooves are formed in the side surface 124′ of the punch 120′, a cutting portion may be additionally formed at an upper side of each accommodation groove, and as a result, n+1 cutting portions may be formed in the punch 120′.

A plurality of cutting portions may sequentially pass over a cut surface of an electrode substrate to remove defects such as burrs generated on the cut surface. Accordingly, the punch 120′ including a plurality of accommodation grooves may more effectively remove defects, and the quality of the cut surface may be further improved.

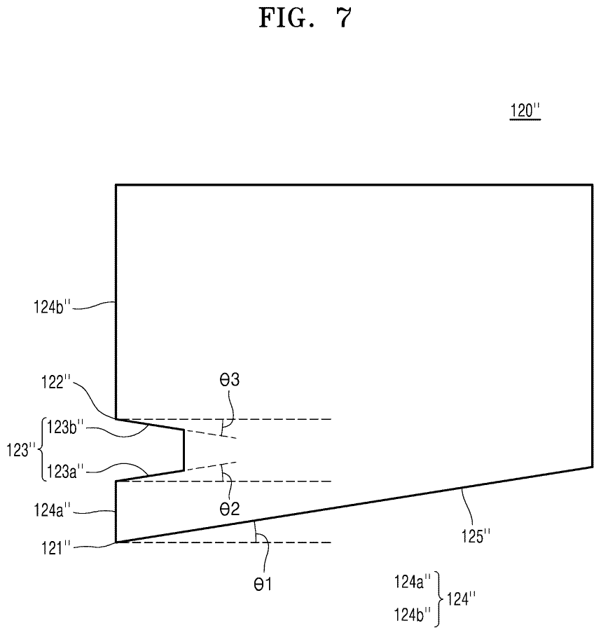

Referring to FIG. 7, an accommodation groove 123″ formed in a side surface 124″ of a punch 120″ may include a first inner surface 123a″ and a second inner surface 123b″, and inclination directions of the first inner surface 123a″ and the second inner surface 123b″ may be opposite to each other.

The first inner surface 123a″ may be inclined upward in a direction away from a first side portion 124a″, and the second inner surface 123b″ may be inclined downward in a direction away from a second side portion 124b″. In some embodiments, a cross-sectional shape of the accommodation groove 123″ may be a trapezoidal or triangular shape.

An inclination angle θ2 of the first inner surface 123a″ and an inclination angle θ3 of the second inner surface 123b″ may have the same value, but embodiments are not limited thereto.

An angle between the second side portion 124b″ and the second inner surface 123b″ may be an obtuse angle of 90 degrees or more. In some embodiments, a second cutting portion 122″ may be formed such that a cutting force is applied in a different direction from that of a first cutting portion 121″.

The punch 120″ may improve the quality of a cut surface of an electrode substrate by creating different directions for a force of cutting the first cutting portion 121″ and a force of cutting the second cutting portion 122″.

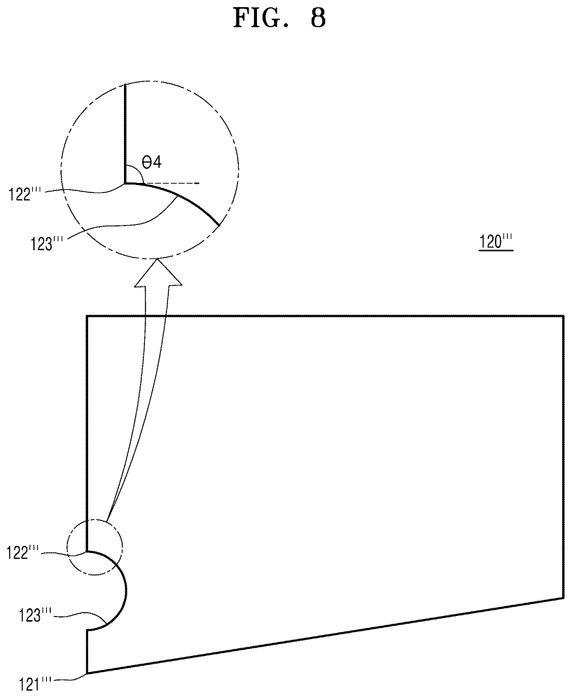

Referring to FIG. 8, an accommodation groove 123″′ of a punch 120″′ may be formed such that an inner surface thereof has a curvature. Accordingly, in some embodiments, a cross-sectional shape of the accommodation groove 123″′ may show a curve such that one or more surfaces of the accommodation groove 123″′ are curved surfaces, such as, for example, the surfaces of the grove forming a semicircular shape or an oval shape.

The inner surface of the accommodation groove 123″′ may have a curvature, and thus an angle θ4 between a side portion corresponding to a second cutting portion 122″′ and the accommodation groove 123″′ may be an obtuse angle of 90 degrees or more. In some embodiments, a cutting surface of the second cutting portion 122″′ in contact with an electrode substrate may have a curvature so that a cutting force of the second cutting portion 122″′ (i.e., a cutting force that has a different direction or size from that of a first cutting portion 121″′) may be applied to the electrode substrate, and the quality of a cutting surface of the electrode substrate may be improved.

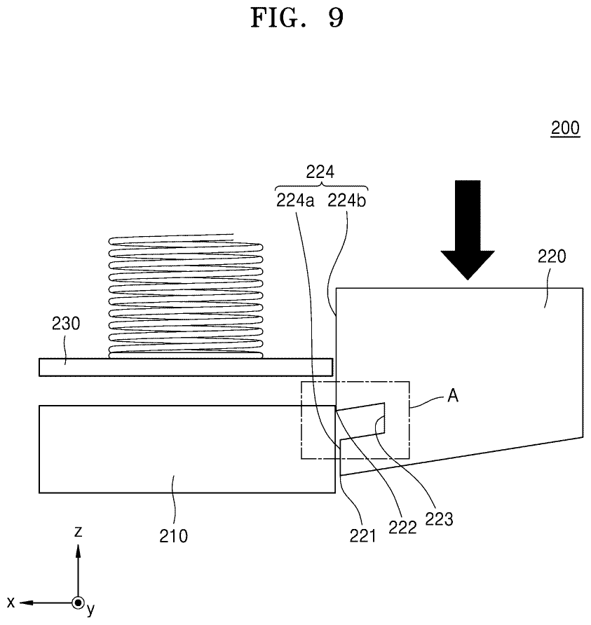

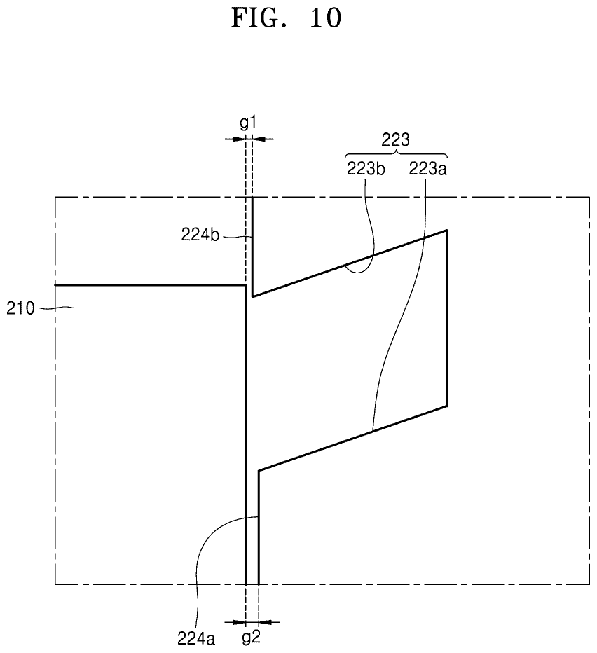

FIG. 9 is a schematic view of a notching device 200 for an electrode substrate for a secondary battery according to embodiments of the present disclosure. FIG. 10 is an enlarged view of area A of FIG. 9 according to embodiments of the present disclosure.

Referring to FIGS. 9 and 10, the notching device 200 for an electrode substrate for a secondary battery may include a die 210, a punch 220, and a stripper 230. The notching device 200 for an electrode substrate for a secondary battery according to the embodiment shown in FIGS. 9 to 10 may be different from the notching device 100 for an electrode substrate for a secondary battery according to the embodiment described with reference to FIGS. 1 to 5D in the structure and arrangement of a side surface 224 of the punch 220. Therefore, the differences described above will be described below, and redundant descriptions will be omitted.

The punch 220 may have an accommodation groove 223 formed in a side surface 224 facing the die 210. A first side portion 224a may be connected to a lower side of the accommodation groove 223, and a second side portion 224b may be connected to an upper side of the accommodation groove 223.

The first side portion 224a may be spaced apart from the die 210 by a first gap g2 in an x-axis direction, and the second side portion 224b may be spaced apart from the die 210 by a second gap g1 in the x-axis direction. In some embodiments, the second gap g1 may be less than the first gap g2. In further embodiments, the second gap g1 may be less than or equal to half of the first gap g2.

The second side portion 224b may have a shorter gap with the die 210 as compared to the first side portion 224a and thus may be closer to the die 210 than the first side portion 224a. Accordingly, a second cutting portion 222 formed at a lower end portion of the second side portion 224b may be disposed closer to the die 210 than a first cutting portion 221.

The first gap g2 may be formed between the first cutting portion 221 and the die 210, and the second gap g1 less than the first gap g2 may be formed between the second cutting portion 222 and the die 210.

When gaps between the die 210 and the first and second cutting portions 221 and 222 are less than an appropriate range during a notching process performed by the notching device 200, a phenomenon in which a cut surface is deformed due to friction between the die 210 and the first and second cutting portions 221 and 222 may occur, and when the gaps between the die 210 and the first and second cutting portions 221 and 222 are greater than an appropriate range, an electrode substrate may be pushed by a downward force of the punch 220, and thus the cut surface may become rough.

Accordingly, the notching device 200 according to another embodiment of the disclosure may perform first cutting through the first cutting portion 221 having a larger gap with the die 210 and then may perform second cutting through the second cutting portion 222 having a smaller gap with the die 210, thereby preventing deformation of the electrode substrate due to friction of first and second cutting portions 221 and 222 and simultaneously more effectively removing defects such as burrs formed on the cut surface of the electrode surface.

As described above, a notching device for an electrode substrate for a secondary battery according to embodiments of the disclosure may include a plurality of cutting portions formed on one punch, thereby more effectively removing defects such as burrs formed on a cut surface of an electrode and improving the work efficiency of a notching process. A to-be-cut portion of an electrode substrate may be cut multiple times so that the electrode substrate may be cut more smoothly, and the quality of a cut surface of an electrode may be improved.

While the disclosure has been described with reference to embodiments illustrated in the drawings, this disclosure provides embodiments that are illustrative. It is to be understood that one skilled in the art may create various equivalent modifications and variations of the embodiments herein without departing from the teachings of the present disclosure.

According to the above disclosure, an electrode substrate may be doubly cut, using a notching device of the present disclosure by a first cutting portion and a second cutting portion, thereby preventing burrs from being generated on a cut surface, and improving the quality of a cut surface of an electrode.

According to embodiments of the present disclosure, a notching process may be simplified, thereby considerably increasing work efficiency and preventing an occurrence of defects of an electrode.

What is claimed is:

1. A notching device for an electrode substrate for a secondary battery, the notching device comprising:
a die configured to receive an electrode substrate thereon;
a stripper configured to press and fix the electrode substrate disposed on the die; and
a punch that moves in a vertical direction that is perpendicular to a first direction, the punch moving next to the die and being configured to cut the electrode substrate disposed on the die,
wherein the punch includes an accommodation groove in a side surface facing the die, the punch dividing the side surface into a first side portion and a second side portion, and the punch extending in the first direction, and
wherein a first cutting portion and a second cutting portion are respectively formed at an end portion of the first side portion and an end portion of the second side portion and are configured to continuously cut a to-be-cut portion of the electrode substrate.

2. The notching device of claim 1, wherein the first cutting portion is connected to a lower surface of the punch, and
wherein the lower surface of the punch has an inclination forming an acute angle with the first side portion.

3. The notching device of claim 1, wherein the accommodation groove includes a first inner surface connected to the first side portion and a second inner surface connected to the second side portion,
wherein the first inner surface and the second inner surface are disposed parallel to each other.

4. The notching device of claim 3, wherein the first inner surface and the second inner surface each have a same inclination as a lower surface of the punch connected to the first side portion of the punch.

5. The notching device of claim 1, wherein the accommodation groove includes a first inner surface connected to the first side portion and a second inner surface connected to the second side portion, the first inner surface and the second inner surface having inclinations of different angles with respect to a line perpendicular to the first side portion.

6. The notching device of claim 1, wherein accommodation groove includes a curved surface.

7. The notching device of claim 1, wherein a separation distance between the first side portion and the second side portion is equal to a depth of the accommodation groove.

8. The notching device of claim 1, wherein the first side portion is spaced apart from the die by a first gap in a second direction, and the second side portion is spaced apart in the second direction from the die by a second gap different from the first gap.

9. The notching device of claim 8, wherein the second gap has a width less than the first gap, and the second gap is positioned higher than the first gap in the vertical direction.

10. The notching device of claim 1, wherein the punch has a plurality of accommodation grooves, which are formed in the side surface, each of the accommodation grooves extending in the first direction and being configured to divide the side surface into a plurality of side portions, and
wherein cutting portions are formed at end portions of the plurality of side portions, the cutting portions being configured to continuously cut the to-be-cut portion of the electrode substrate.

11. A notching device for an electrode substrate for a secondary battery, the notching device comprising:
a die configured to receive an electrode substrate thereon;
a stripper configured to press and fix the electrode substrate disposed on the die; and
a punch, which moves in a vertical direction that is perpendicular to a first direction, the punch moving next to the die and being configured to cut the electrode substrate disposed on the die,
wherein the punch includes a first cutting portion and a second cutting portion, which are spaced apart from each other in the vertical direction of the punch and are configured to continuously cut a to-be-cut portion of the electrode substrate, and
wherein an accommodation groove is formed between the first cutting portion and the second cutting portion and is recessed from a side surface of the punch by a depth.

12. The notching device of claim 11, wherein the first cutting portion is connected to a lower surface of the punch, and the lower surface of the punch is inclined in the vertical direction.

13. The notching device of claim 11, wherein the accommodation groove includes a first inner surface and a second inner surface facing the first inner surface, and the first inner surface and the second inner surface are parallel to each other.

14. The notching device of claim 13, wherein the first inner surface and the second inner surface have a same inclination as a lower surface of the punch.

15. The notching device of claim 11, wherein the accommodation groove includes a first inner surface and a second inner surface facing the first inner surface, the first inner surface and the second inner surface having inclinations of different angles with respect to a line perpendicular to the side surface.

16. The notching device of claim 11, wherein the accommodation groove has a curved surface.

17. The notching device of claim 11, wherein a length of the accommodation groove in the vertical direction is equal to a depth of the accommodation groove.

18. The notching device of claim 11, wherein the first cutting portion and the second cutting portion are respectively connected to a first side portion and a second side portion, the first side portion is spaced apart from the die by a first gap in a second direction, and the second side portion is spaced apart from the die by a second gap different from the first gap in the second direction.

19. The notching device of claim 18, wherein the second gap has a width less than the first gap and the second gap is positioned higher than the first gap in the vertical direction.

20. The notching device of claim 11, wherein the punch has a plurality of accommodation grooves, which are formed in the side surface, extend in the first direction, and divide the side surface into a plurality of side portions, and
wherein cutting portions are formed at end portions of the side portions and are configured to continuously cut the to-be-cut portion of the electrode substrate.
